(19) United States
(12) Patent Application Publication
(10) Pub. No.: US 2019/0376451 A1
(43) Pub. Date: Dec. 12, 2019

(54) PRIMARY NOZZLE OF A TURBOMACHINE PRIMARY EXHAUST DUCT

(71) Applicant: Airbus Operations SAS, Toulouse (FR)

(72) Inventors: Thierry GACHES, CASTELNAU D'ESTRETEFONDS (FR); Lionel CZAPLA, CORNEBARRIEU (FR); Bastian SABATHIER, FONSORBES (FR)

(21) Appl. No.: 16/419,798

(22) Filed: May 22, 2019

(30) Foreign Application Priority Data
Jun. 11, 2018 (FR) 1855081

(51) Int. Cl. F02C 7/24; F01D 9/02

(52) U.S. Cl. CPC F02C 7/24; F05D 2260/96; F01D 9/02

(57) ABSTRACT

A primary nozzle of a turbomachine primary exhaust duct, the primary nozzle comprising a microperforated first wall facing towards the inside and which widens from the front as far as an intermediate zone, a one-piece second wall comprising a microperforated internal part which extends rearward and in the continuity of the first wall from the intermediate zone and narrows from the intermediate zone rearwards, an external part which faces towards the outside around the internal part, and a fold connecting the rear parts of the internal part and of the external part, where the first wall and the internal part are fixed to one another, and a noise attenuating element fixed to the first wall and to the internal part.

### CROSS-REFERENCES TO RELATED APPLICATIONS

This application claims the benefit of the French patent application No. 1855081 filed on Jun. 11, 2018, the entire disclosures of which are incorporated herein by way of reference.

### FIELD OF THE INVENTION

The present invention relates to a primary nozzle of a turbomachine primary exhaust duct, to a turbomachine comprising such a primary nozzle, and to an aircraft comprising at least one such turbomachine.

### BACKGROUND OF THE INVENTION

A turbomachine conventionally comprises, from the front towards the rear, an air inlet via which air enters the turbomachine, an engine which combusts the air and fuel, and a primary exhaust duct via which the burnt gases are discharged.

FIG. 9 shows the rear part of a turbomachine which forms a primary exhaust duct 802 via which the gases burnt by the turbomachine are exhausted and which is delimited on the outside by a primary nozzle 804 and on the inside by an internal structure 806 of the primary exhaust duct 802.

An exhaust bullet 808 is fixed to the rear of the internal structure 806.

FIG. 10 shows a cross section through the primary nozzle 804 on an axial plane.

The primary nozzle 804 of the prior art comprises an internal wall 902 which faces towards the internal structure 806 and which with the internal structure 806 delimits a channel via which the burnt gases are exhausted. The internal wall 902 is microperforated.

The primary nozzle 804 comprises an external wall 904 which faces towards the outside around the internal wall 902 and which is therefore in contact with a flow of air that is colder than the burnt gases.

The external wall 904 and the internal wall 902 each adopt the overall shape of a cylinder and meet at their rear ends. The rear ends are pressed against one another and fixed together by fasteners 906, for example of the countersunk screw (or rivet) type.

The external wall 904 narrows from the front towards the rear whereas the internal wall 902 widens from the front as far as an intermediate zone 908 corresponding more or less to a maximum before narrowing from the intermediate zone towards the rear.

In order to attenuate noise, a noise attenuating element 910, for example a honeycomb structure, is attached to the internal wall 902 between the internal wall 902 and the external wall 904.

Because the internal wall 902 is subjected to high temperatures, it experiences thermal expansion and the attachment by the fasteners 906 does not prevent the internal wall 902 from deforming In order to prevent the noise attenuating element 910 from becoming crushed between the internal wall 902 and the external wall 904, it is necessary to leave a clearance between the noise attenuating element 910 and the external wall 904.

Overall, from the intermediate zone 908 onward, it becomes impossible to fit the noise attenuating element 910 between the internal wall 902 and the external wall 904, and this limits the noise attenuation.

### SUMMARY OF THE INVENTION

It is an object of the present invention to propose a primary nozzle of a turbomachine primary exhaust duct that allows noise attenuating elements to be fitted over a larger surface area of the primary nozzle.

To this end, the invention proposes a primary nozzle of a turbomachine primary exhaust duct, the primary nozzle comprising:

a microperforated first wall, facing towards the inside of the primary nozzle, and which widens from the front as far as an intermediate zone,

a one-piece second wall comprising a microperforated internal part which extends rearwards from the first wall and in continuity therewith from the intermediate zone and narrows from the intermediate zone rearwards, an external part which faces towards the outside of the primary nozzle around the internal part, and a fold connecting the rear parts of the internal part and of the external part, where the first wall and the internal part are fixed to one another, and

a noise attenuating element fixed to the first wall and to the internal part, and arranged, on the one hand, between the first wall and the external part and, on the other hand, between the internal part and the external part.

Such a primary nozzle therefore makes it possible to limit the movements of the internal part with respect to the external part and it therefore becomes possible to position a noise attenuating element over a larger surface area.

Advantageously, the front end of the internal part has a discontinuity towards the outside and the depth of this discontinuity is able to house the rear end of the first part so that the face of the first wall that faces towards the inside of the primary nozzle lies flush with the face of the internal part that faces towards the inside of the primary nozzle.

Advantageously, the external part is made up of a rear external part which extends from the fold forwards as far as a junction zone, and a front external part which extends from the junction zone to the front, and the front end of the rear external part and the rear end of the front external part are fixed to one another.

Advantageously, the front end of the rear external part has a discontinuity towards the inside, and the depth of this discontinuity is able to house the rear end of the front external part so that the face of the rear external part that faces towards the outside of the primary nozzle lies flush with the face of the front external part that faces towards the inside of the primary nozzle.

The invention also proposes a turbomachine comprising a primary exhaust duct delimited on the outside by a primary nozzle according to one of the preceding alternative forms and on the inside by an internal structure.

The invention also proposes an aircraft comprising at least one turbomachine according to the above alternative form.

### BRIEF DESCRIPTION OF THE DRAWINGS

The abovementioned features of the invention, together with others, will become more clearly apparent from reading the following description of one exemplary embodiment, the description being given in connection with the attached drawings, among which:

FIG. 1 is a side view of an aircraft according to the invention,

FIG. 2 is a side view in cross section on an axial plane of a primary nozzle according to a first embodiment of the invention,

FIG. 3 is a side view in cross section on an axial plane of a primary nozzle according to a second embodiment of the invention,

FIG. 4 is an enlargement of detail III of FIG. 2 and of FIG. 3,

FIG. 5 is an enlargement of detail IV FIG. 2,

FIG. 6 is a view corresponding to FIG. 5 for an alternative form of embodiment,

FIG. 7 shows the fitting of special noise attenuating elements,

FIG. 8 shows a view in cross section of an alternative way of attaching the primary nozzle according to the invention,

FIG. 9 shows a rear part of a turbomachine which forms a primary exhaust duct, and

FIG. 10 shows a cross section of a primary nozzle of the prior art on an axial plane.

### DETAILED DESCRIPTION OF THE PREFERRED EMBODIMENTS

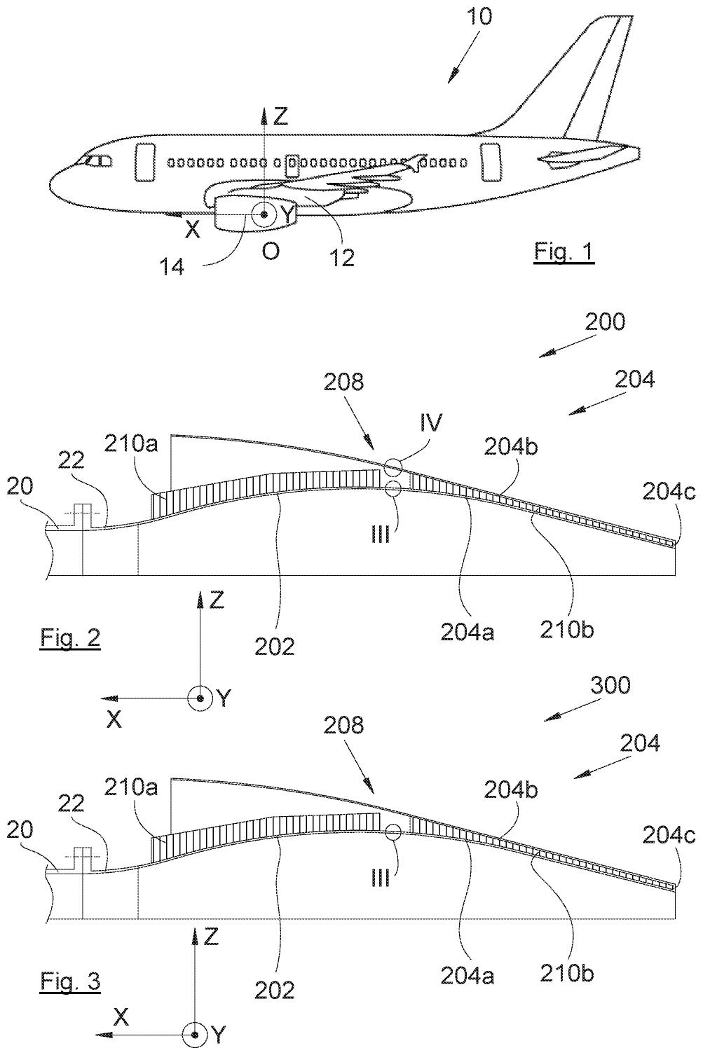

FIG. 1 shows an aircraft 10 which comprises a wing 12 beneath which is fixed a nacelle 14 in which a turbomachine is housed.

In the description which follows, and by convention, the longitudinal axis of the turbomachine, oriented positively in the direction of forward travel of the aircraft 10, and which is also the longitudinal axis of the nacelle 14, is referred to as X, and the transverse axis, which is horizontal when the aircraft 10 is on the ground, is referred to as Y, and the vertical axis or vertical height, when the aircraft 10 is on the ground, is referred to as Z, these three directions X, Y and Z being mutually orthogonal and forming an orthonormal frame of reference.

In the description which follows, terms relating to a position are considered with reference to the orientation of the aircraft 10 when making forward progress.

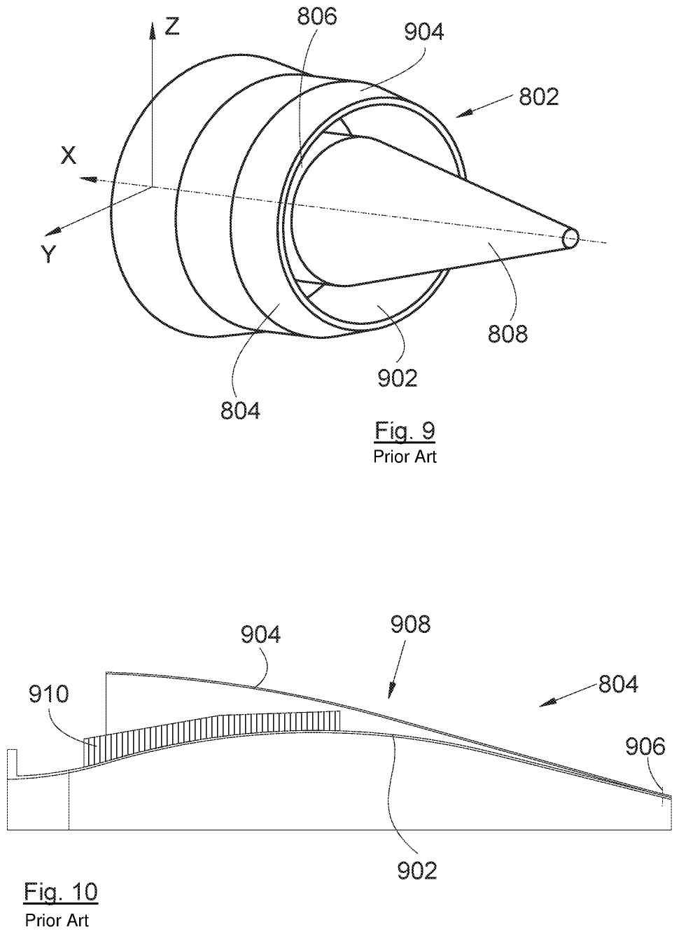

The turbomachine comprises, at the rear, a primary exhaust duct which comprises the same elements as that of FIG. 9. The gases burnt by the turbomachine are discharged via the primary exhaust duct which is delimited on the outside by a primary nozzle and on the inside by an internal structure of the primary exhaust duct.

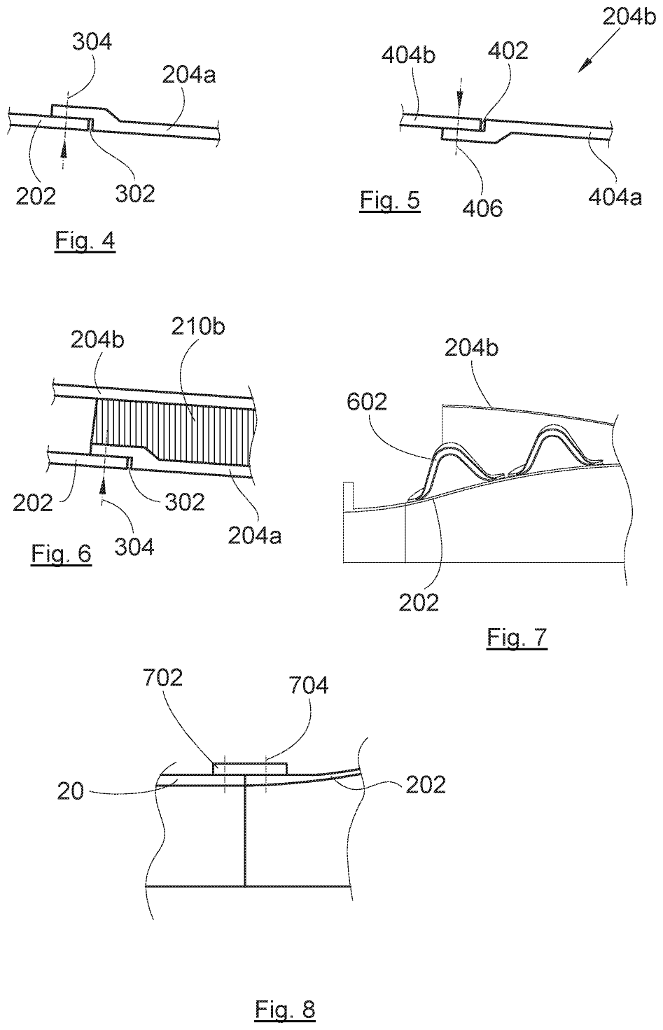

FIG. 2 shows a side view of a primary nozzle 200 according to a first embodiment of the invention. FIG. 3 shows a side view of a primary nozzle 300 according to a second embodiment of the invention. FIG. 4 shows an enlargement of detail III which is common to the two embodiments, and FIG. 5 shows an enlargement of detail IV of the first embodiment of the invention.

The primary nozzle 200, 300 comprises a first wall 202 which faces towards the internal structure, namely towards the inside of the primary nozzle 200 and which widens from the front as far as an intermediate zone 208 which generally corresponds to a maximum. The first wall 202 is microperforated in order to allow the air to pass.

The primary nozzle 200, 300 comprises a second wall 204 which comprises an internal part 204a which extends to the rear of the first wall 202 and in continuity therewith from the intermediate zone 208 and narrows from the intermediate zone 208 towards the rear. The first wall 202 and the internal part 204a, with the internal structure, delimit a channel along which the burnt gases are exhausted. The internal part 204a is microperforated in order to allow the air to pass.

The second wall 204 also comprises an external part 204b which faces towards the outside of the primary nozzle 200, 300 around the internal part 204a and which is therefore in contact with a flow of air which is colder than the burnt gases.

The internal part 204a and the external part 204b form one and the same element and are secured to one another at their rear parts by a fold 204c which connects them, and which forms the rear end of the second wall 204 and of the primary nozzle 200, 300. The fold 204c is at 180°.

As FIG. 4 shows, the rear end of the first wall 202 and the front end of the internal part 204a are fixed to one another.

The one-piece structure of the second wall 204 makes it possible to limit movements between the internal part 204a and the external part 204b and it is therefore possible to fit a noise attenuating element 210a-b over a larger surface area of the primary nozzle 200, 300 and thus improve noise attenuation.

The separation between the first wall 202 and the second wall 204 facilitates access to the zone between the internal part 204a and the external part 204b.

The noise attenuating element 210a-b is made up here of two independent elements in which the first element 210a is fixed to the outwardly facing face of the first wall 202 and in which the second element 210b is fixed to the outwardly facing face of the internal part 204a. The noise attenuating element 210a-b is thus positioned, on the one hand, between the first wall 202 and the external part 204b and, on the other hand, between the internal part 204a and the external part 204b.

The first wall 202 takes the overall shape of a cylinder. The internal part 204a and the external part 204b each take the overall form of a cylinder.

In order to limit perturbations of the stream of burnt gases at the junction between the first wall 202 and the internal part 204a, this junction is rendered flat by making a discontinuity 302 in the front end of the internal part 204a towards the outside of the primary nozzle 200, 300 and in which the depth of this discontinuity 302 is able to house the rear end of the first wall 202 so that the face of the first wall 202 that faces towards the inside of the primary nozzle 200, 300 lies flush with the face of the internal part 204a that faces towards the inside of the primary nozzle 200, 300.

The joining-together of the first wall 202 and of the internal part 204a is achieved by any suitable fasteners 304, such as countersunk rivets or screws for example which are screwed in from the inside of the primary nozzle 200, 300.

In the first embodiment of the invention and to make the external part 204b easier to create, this is made up of a rear external part 404a and of a front external part 404b as shown in FIG. 5. The rear external part 404a extends from the fold 204c forward as far as a junction zone which here corresponds substantially to the intermediate zone 208. The front external part 404b extends the rear external part 404a and extends from the junction zone as far as the front.

The front end of the rear external part 404a and the rear end of the front external part 404b are fixed to one another.

In order to limit perturbations of the flow of air over the external part 204b at the junction between the rear external part 404a and the front external part 404b, this junction is rendered flat by creating a discontinuity 402 in the front end of the rear external part 404a towards the inside of the primary nozzle 200 in which the depth of this discontinuity 402 is able to house the rear end of the front external part 404b so that the face of the rear external part 404a at the discontinuity that faces towards the outside of the primary nozzle 200 lies flush with the face of the front external part 404b that faces towards the inside of the primary nozzle 200.

The rear external part 404a and the front external part 404b are fixed together by any suitable fasteners 406 such as countersunk rivets or screws for example which screw in from the outside of the primary nozzle 200.

The noise attenuating element 210a-b may adopt various forms according to the frequencies of the noises that are to be attenuated.

In the embodiment of FIG. 3, the first element 210a and the second element 210b each comprise a honeycomb structure aimed at high frequencies.

As FIG. 7 shows, it is equally possible to replace the honeycomb structure with cones 602, the open bases of which are fixed to the microperforated wall, in this instance the first wall 202. Cones may also be fixed to the internal part 204a. A cone targets high frequencies or high and low frequencies, depending on its structure.

As FIG. 6 shows, the honeycomb structure that makes up the second element 210b may cover the internal part 204a as far as its front end.

The primary nozzle 200, 300, namely the first wall 202 and the second wall 204, may be made of metal, but are preferably made of titanium, nickel alloy, or ceramic. It is also possible to have a first wall 202 made of metal, titanium or nickel alloy, and a second wall 204 made of ceramic.

In the embodiment of the invention depicted in FIGS. 2 and 3, the primary nozzle 200, 300 is fixed to the structure 20 of the turbomachine by means of a flange 22 to which the front end of the first wall 202 is welded.

In the embodiment of the invention shown in FIG. 8, the first wall 202 is fixed to the structure 20 by means of the fitting of a plurality of fish plates 702 which are distributed around the periphery of the junction between the structure 20 and the first wall 202 and in which each fish plate 702 is fixed to the structure 20 and to the first wall 202 by suitable fasteners 704, such as screws, for example.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A primary nozzle of a turbomachine primary exhaust duct, the primary nozzle comprising:
a microperforated first wall, facing towards an inside of the primary nozzle, and which widens from a front as far as an intermediate zone,
a one-piece second wall, comprising
a microperforated internal part, which extends rearwards from the first wall and in continuity therewith from the intermediate zone, and narrows from the intermediate zone rearwards,
an external part which faces towards an outside of the primary nozzle around the internal part, and
a fold connecting rear parts of the internal part and of the external part, where the first wall and the internal part are fixed to one another, and
a noise attenuating element fixed to the first wall and to the internal part, and arranged between the first wall and the external part and between the internal part and the external part.

2. The primary nozzle according to claim 1, wherein a front end of the internal part has a discontinuity towards the outside and wherein a depth of the discontinuity is sized to house a rear end of the first wall so that a face of the first wall that faces towards the inside of the primary nozzle lies flush with a face of the internal part that faces towards the inside of the primary nozzle.

3. The primary nozzle according to claim 1, wherein the external part is made up of a rear external part which extends from the fold forward as far as a junction zone, and a front external part which extends from the junction zone to the front, and wherein a front end of the rear external part and a rear end of the front external part are fixed to one another.

4. The primary nozzle according to claim 3, wherein the front end of the rear external part has a discontinuity towards the inside and wherein a depth of the discontinuity is able to house the rear end of the front external part so that a face of the rear external part at the discontinuity that faces towards the outside of the primary nozzle lies flush with a face of the front external part that faces towards the inside of the primary nozzle.

5. A turbomachine comprising a primary exhaust duct delimited on the outside by a primary nozzle according to claim 1 and on the inside by an internal structure.

6. An aircraft comprising at least one turbomachine according to claim 5.
